(19) United States
(12) Patent Application Publication
(10) Pub. No.: US 2020/0206081 A1
(43) Pub. Date: Jul. 2, 2020

(54) Anti-dumping transport box for medical drugs

(71) Applicant: Guocheng Qian, Guangzhou City (CN)

(72) Inventor: Guocheng Qian, Guangzhou City (CN)

(21) Appl. No.: 16/812,401

(22) Filed: Mar. 9, 2020

(30) Foreign Application Priority Data
Nov. 26, 2019 (CN) 2019111771119

(51) Int. Cl. A61J 1/16; A61J 1/14; B65D 81/05

(52) U.S. Cl. CPC A61J 1/16; A61J 1/1412; F16F 15/04; A61J 1/1493; B65D 81/05

(57) ABSTRACT

The invention discloses an anti-dumping transport box for medical drugs, which includes a box body. The box body is provided with a cavity. The cavity is provided with a clamping mechanism. The clamping mechanism passes through a sealing plate and a packaging box. Five test tubes can be clamped, the medicine is stored in the storage chamber in the test tube, and the sealing piston in the clamping mechanism can seal the storage chamber. The present invention can hold the test tube vertically and pass The sealed piston is sealed to prevent leakage of the drug, and to keep the drug in an environment filled with inert gas, to prevent gas with more impurities such as air from entering the test tube and contaminating the drug, and to reduce the upper and lower test tubes during transportation. The amplitude of the vibration and the angle of inclination can prevent the tube from leaking the drug due to the large inclination.

### CROSS-REFERENCES TO RELATED APPLICATIONS

The present application claims priority from Chinese application No. 2019111761367 filed on Sep. 19, 2019 which is hereby incorporated by reference in its entirety.

### TECHNICAL FIELD

The invention relates to the field of material transportation, in particular to an anti-dumping transport box for medical drugs.

### BACKGROUND OF THE INVENTION

In modern society, hospitals often use scarce drugs when treating patients, and sometimes need to be transported from other hospitals. Because these drugs are scarce and valuable, and are urgently needed to treat patients, they need to be protected during transportation. Measures, the existing drugs are only transported by ordinary transport vehicles. When the vehicle is bumpy, the transported drugs and their containers will also vibrate in the vehicle, even dumping the drugs to cause waste, and even affect the treatment of patients. The invention discloses an anti-dumping transport box for medical drugs, which can solve the above problems.

### BRIEF SUMMARY OF THE INVENTION

### Technical Problem

In the prior art, medicines are transported only by a general transport vehicle, and the medicine is easily poured out when the vehicle is bumpy.

In order to solve the above problems, an anti-dumping transport box for medical drugs is designed in this example. An anti-dumping transport box for medical drugs in this example includes a box body, which is fixed in a transport vehicle. There is a cavity, and a clamping mechanism is provided in the cavity. The clamping mechanism can hold five test tubes through a sealing plate and a packaging box, and the medicine is stored in a storage cavity in the test tube. The sealing piston in the clamping mechanism can seal the storage cavity to isolate the drug from the outside environment of the test tube. Friction pads are fixed at the four corners between the sealing plate and the packaging box. Four buffer rods are arranged in a circular array in the cavity and can slide up and down. The buffer rods are in contact with the friction pads and are connected to the sealing plate and the packing box. The buffer rods are in contact with the friction. The friction between the pads is equivalent to the weight after the clamping mechanism holds five of the test tubes, that is, the buffer rod, the sealing plate, and the packing box can be kept relatively stationary. The sealing plate and the packing box are Under the action, relative sliding will occur with the buffer rod, and finally the sealing plate and the packing box and the buffer rod will return to a relatively static state. A buffer mechanism is connected to the upper and lower ends of the buffer rod, and the buffer mechanism It can buffer the up and down vibration and tilt of the buffer rod, which can reduce the vibration and tilt amplitude of the buffer rod, thereby avoiding the test tube vibration and tilt amplitude in the clamping mechanism from being too large, resulting in drugs The storage chamber is leaked, and a manual mechanism is screw-connected to the upper end of the sealing plate. The manual mechanism can be used to control the sealing plate to separate the sealing plate from the packing box. Plate, a baffle shaft is fixedly connected to the baffle, the left and right ends of the baffle shaft are rotatably connected to the inner walls of the left and right sides of the cavity, the baffle can close or open the cavity, and the box An air outlet pipe is fixedly connected to the upper end of the body. An air outlet passage is provided in the air outlet pipe, and the air outlet passage is connected to the cavity. A valve is fixed in the air outlet passage, and the valve can be opened in both directions, that is, When said valve is open to the cavity through the outlet passage to said pneumatic cavity when the valve is open to outside the cavity, the cavity may be a gas discharge.

Advantageously, the manual mechanism includes a support limit plate fixedly connected to the inner wall of the rear side of the cavity, a screw is rotatably connected to the support limit plate, and a screw hole with an opening upward is provided in the sealing plate. The lower end of the screw extends into the threaded hole and is screw-connected to the sealing plate. A connecting shaft is slidably and rotatably provided on the upper side of the support limit plate. A connecting hole, wherein the upper end of the connecting shaft extends out of the box and a manual plate is fixedly connected, pushing the manual plate and driving the connecting shaft to slide down, so that the upper end of the screw extends into the connecting hole and communicates with When the connecting shaft is connected, the manual plate is rotated at this time, and then the screw is driven to rotate by the connecting shaft, thereby driving the sealing plate to rise and fall. The support limit plate can support the screw and can move the screw. Limits are imposed when the seal plate slides.

Preferably, a compression spring is fixedly connected to the upper end of the box, and the upper end of the compression spring abuts against the manual plate, and the manual plate is released, and the manual plate can be pushed by the elastic force of the compression spring. Sliding, thereby driving the connecting shaft to slide up and disconnect from the screw.

Beneficially, the clamping mechanism includes a storage cavity provided in the packaging box with an upward opening, the storage cavity is fixed with a bottom plate, the bottom plate is provided with five grooves with upward openings, and the upper end of the bottom plate Five support pillars are fixed, and a clamping plate is fixedly connected to the upper end of the support pillar, the clamping plate clamps the test tube, and the lower end of the test tube extends into the groove, and then passes through the bottom plate and the clamping plate keeps the test tube upright, and five sealing holes with downward openings are provided in the sealing plate. The upper end of the test tube extends into the sealing hole, and the sealing piston is fixedly connected to the seal. On the inner wall of the upper side of the hole, after the clamping plate and the bottom plate clamp the test tube, the sealing plate slides down and the upper end of the test tube extends into the sealing hole, while the sealing piston extends into the sealing hole. The storage cavity is sealed in the storage cavity.

Preferably, the packaging box is provided with an opening upward guide hole symmetrically on the left and right sides, and a guide rod is fixedly connected on the lower end of the sealing plate symmetrically on the left and right sides, and the guide rod can slide along the guide hole, thereby making the upper end of the test tube can slide into the sealing hole to prevent the upper end of the test tube from colliding with the sealing plate.

Beneficially, the buffer mechanism includes buffer boxes slidably connected to the upper and lower ends of the buffer rod, respectively. The buffer box is provided with an air storage cavity whose opening faces the center of symmetry, and the upper and lower ends of the buffer rod respectively extend to the buffer box. In the air storage cavity, ventilation channels are symmetrically and communicated in the inner walls of the left and right sides of the air storage cavity. A ventilation valve is fixed in the ventilation channel, and the opening directions of the ventilation valve on both sides are provided. On the contrary, the opening of the ventilation valve on one side faces the air storage cavity, the opening of the ventilation valve on the other side faces the cavity, and a connecting rod is fixedly connected to one end of the buffer box away from the center of symmetry. There are eight roller grooves connected in the inner wall of the cavity, the link extends into the spring groove and can slide along the spring groove, and the link is fixedly connected with the inner wall of the spring groove. A buffer spring, when the transport vehicle vibrates up and down, the buffer rod vibrates up and down, and then squeezes the gas in the air storage chamber, and the air can be fed into or out of the air storage chamber through the two ventilation valves That is, when the buffer rod squeezes the gas in the gas storage cavity and increases the pressure The gas in the gas storage cavity is discharged into the cavity through the ventilation valve on one side, and when the air pressure in the gas storage cavity is reduced, the gas is removed from the gas storage valve through the ventilation valve on the other side. Intake air into the air-storage cavity from the cavity, so that the air pressure in the air-storage cavity can be dynamically balanced, which can reduce the amplitude of the shock of the buffer rod up and down, and can further reduce the sealing plate and the packaging The amplitude of the vibration of the box up and down. When the transport vehicle is tilted, the buffer lever drives the buffer box to tilt, which in turn drives the connecting rod to tilt, and then squeezes or stretches the buffer spring, and then the elasticity of the buffer spring. Under the action, the inclination angle of the connecting rod is reduced, so that the inclination angle of the buffer box and the buffer rod can be reduced, and the inclination angle of the sealing plate and the packaging box can be reduced. The drug in the storage chamber leaked out.

Preferably, six roller grooves are provided on the inner surface of the buffer rod, and a guide pulley is rotatably provided in the roller groove. A fixed shaft is fixedly connected to the guide pulley, and the fixed shaft is rotationally connected. In the buffer rod, an annular groove with an outward opening is provided in the guide pulley, and six guide slide rails are fixed in the inner wall of the gas storage cavity, and the guide slide rail extends into the annular groove. The guide pulley can roll along the guide slide to guide sliding between the buffer rod and the air storage cavity.

The beneficial effect of the present invention is that the present invention can hold the test tube vertically and seal it with a sealing piston, thereby avoiding leakage of the drug, and keeping the drug in an environment filled with inert gas, and avoiding more impurities such as air. The gas enters the test tube and contaminates the drug, and during transportation, it can reduce the amplitude of the vertical vibration of the test tube and the angle of inclination, thereby preventing the test tube from leaking the drug due to excessive tilt.

### BRIEF DESCRIPTION OF THE DRAWINGS

For ease of explanation, the present invention is described in detail by the following specific embodiments and the accompanying drawings.

1 is a schematic diagram of the overall structure of an anti-dumping transport case for medical drugs according to the present invention;

FIG. 2 is an enlarged schematic view of “A” of FIG. 1; FIG.

FIG. 3 is an enlarged schematic view of “B” of FIG. 1; FIG.

FIG. 4 is a schematic structural diagram of the “C-C” direction of FIG. 1; FIG.

FIG. 5 is a schematic structural diagram of the “D-D” direction of FIG. 1; FIG.

FIG. 6 is a schematic structural view of the “E-E” direction of FIG. 3.

### DETAILED DESCRIPTION OF THE INVENTION

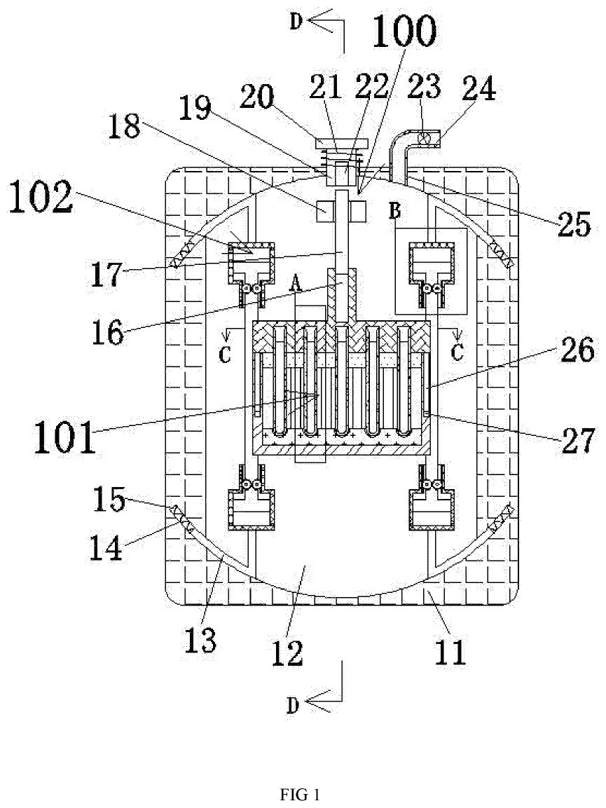

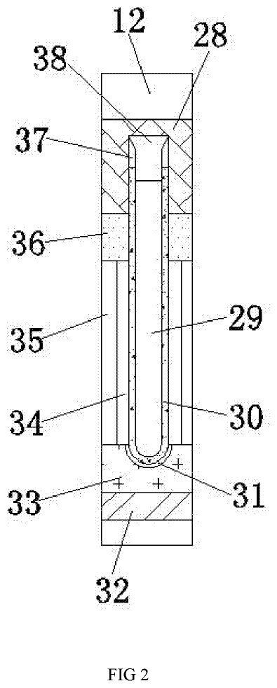

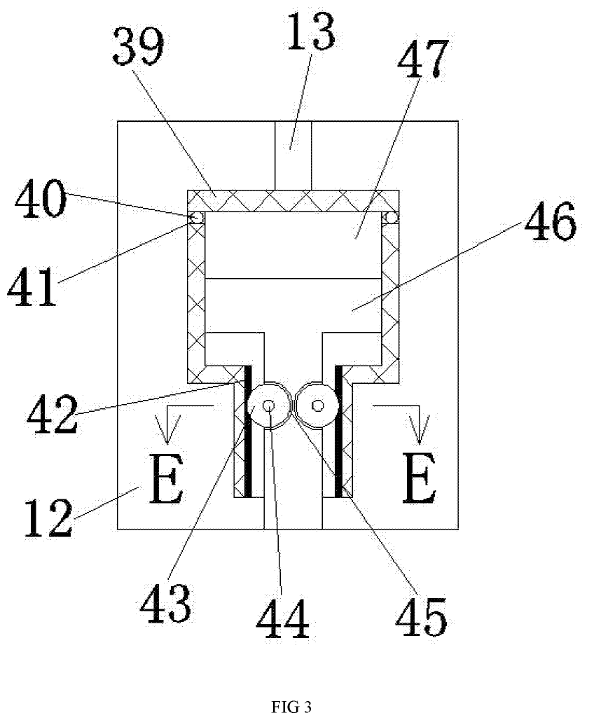

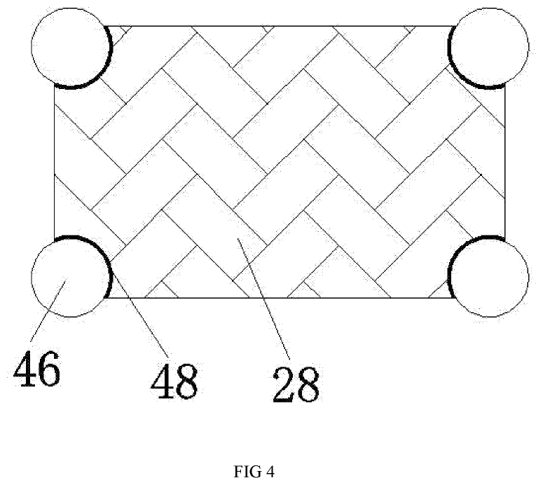

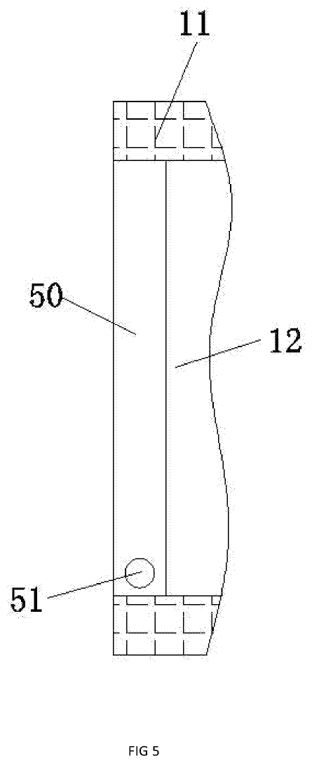

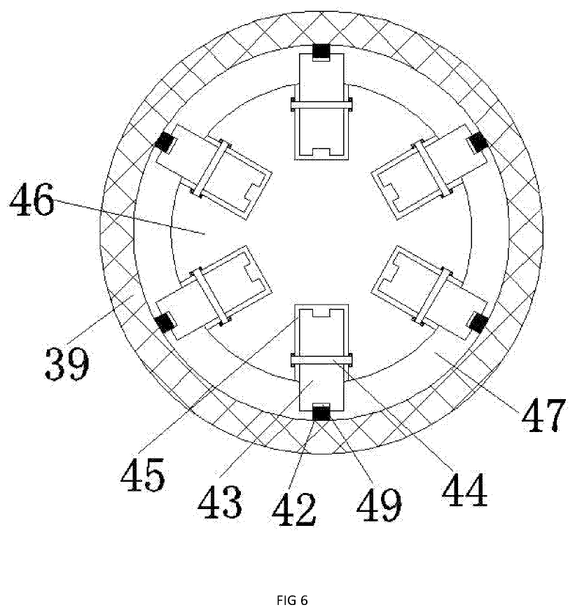

The present invention is described in detail below with reference to FIGS. 1 to 6. For convenience of description, the orientation described below is defined as follows: the up-down, left-right, front-back direction described below is consistent with the up-down, left-right, front-back direction of the projection relationship of FIG. 1 itself.

An anti-dumping transport box for medical drugs according to the present invention includes a box body 11 which is fixed in a transport vehicle, and a cavity 12 is provided in the box body 11 and a cavity 12 is provided in the cavity 12. A clamping mechanism 101 in which five test tubes 30 can be clamped by a sealing plate 28 and a packaging box 32 in the clamping mechanism 101, and a medicine is stored in a storage cavity 29 in the test tube 30, and the clamping mechanism 101 The inner sealing piston 38 can seal the storage cavity 29 to isolate the medicine from the environment outside the test tube 30. Friction pads 48 are fixed at four corners between the sealing plate 28 and the packaging box 32. Four buffer rods 46 are arranged in a circular array in the cavity 12 and can slide up and down. The buffer rods 46 are in contact with the friction pad 48 and are connected to the sealing plate 28 and the packing box 32. The frictional force between the buffer lever 46 and the friction pad 48 is equivalent to the weight of the clamping mechanism 101 after clamping the five test tubes 30, that is, the buffer lever 46 and the sealing plate 28 And the packaging box 32 can be kept relatively stationary. When the sealing plate 28 and the packaging box 32 are losing weight or Under heavy action, relative sliding will occur with the buffer lever 46, and finally the sealing plate 28 and the packing box 32 will return to a relatively static state with the buffer lever 46, and buffers are connected to the upper and lower ends of the buffer lever 46 Mechanism 102, the buffer mechanism 102 can buffer the up and down vibration and tilt of the buffer lever 46, thereby reducing the vibration and tilt of the buffer lever 46, and thereby avoiding all the problems in the clamping mechanism 101 The test tube 30 is shaken and tilted too much, causing the drug to leak out of the storage cavity 29. A manual mechanism 100 is threadedly connected to the upper end of the sealing plate 28. By manually controlling the manual mechanism 100, the sealing plate 28 and the packing box 32 is separated, and a baffle 50 is rotatably provided in the cavity 12. A baffle shaft 51 is fixedly connected to the baffle 50. The left and right ends of the baffle shaft 51 are rotatably connected to the baffle shaft 51. The inner wall of the left and right sides of the cavity 12, the baffle 50 can close or open the cavity 12, an upper end of the box 11 is fixedly connected with an air outlet pipe 25, and an air outlet channel 24 is provided through the air outlet pipe 25, The air outlet channel 24 communicates with the cavity 12, so A valve 23 is fixed in the air outlet channel 24, and the valve 23 can be opened in both directions, that is, when the valve 23 is opened into the cavity 12, it can be inflated into the cavity 12 through the air outlet channel 24. When the valve 23 is opened to the outside of the cavity 12, the gas in the cavity 12 can be exhausted.

According to an embodiment, the manual mechanism 100 is described in detail below. The manual mechanism 100 includes a support limit plate 18 fixedly connected to the inner wall on the rear side of the cavity 12, and the support limit plate 18 is rotationally connected inside. There is a screw 17, and the sealing plate 28 is provided with a screw hole 16 with an upward opening therein. The lower end of the screw 17 extends into the screw hole 16 and is threadedly connected to the sealing plate 28. The support limit plate 18 is A connecting shaft 19 is slidably and rotatably provided on the side. The connecting shaft 19 is provided with a connection hole 22 which is open downward. The upper end of the connecting shaft 19 extends to the outside of the box 11 and is fixedly connected with a manual plate 20. Pushing the manual plate 20 and driving the connecting shaft 19 down, so that the upper end of the screw 17 extends into the connecting hole 22 and is connected to the connecting shaft 19, at this time, the manual plate 20 is rotated, and further The connecting shaft 19 drives the screw 17 to rotate, which in turn drives the sealing plate 28 to rise and fall. The support limit plate 18 can support the screw 17 and can limit the position of the sealing plate 28 when it slides up.

Beneficially, a compression spring 21 is fixedly connected to the upper end of the box 11, and the upper end of the compression spring 21 abuts against the manual plate 20, and the manual plate 20 is released, and can be pushed by the elastic force of the compression spring 21. The manual plate 20 slides up, and further drives the connecting shaft 19 to slide up and disconnects from the screw 17.

According to an embodiment, the clamping mechanism 101 is described in detail below. The clamping mechanism 101 includes a storage cavity 34 provided in the packaging box 32 with an upward opening, and a bottom plate 33 is fixed in the storage cavity 34. The bottom plate 33 is provided with five grooves 31 with upward openings. Five support pillars 35 are fixed on the upper end of the bottom plate 33. A clamping plate 36 is fixed to the upper end of the support pillar 35. The test tube 30 is clamped, the lower end of the test tube 30 extends into the groove 31, and the test tube 30 is kept vertical by the bottom plate 33 and the clamping plate 36, and the sealing plate 28 is provided inside There are five sealing holes 37 that open downward. The upper end of the test tube 30 extends into the sealing hole 37. The sealing piston 38 is fixed to the upper inner wall of the sealing hole 37. The clamping plate 36 and After the bottom plate 33 grips the test tube 30, the sealing plate 28 slides and the upper end of the test tube 30 extends into the sealing hole 37, and at the same time, the sealing piston 38 extends into the storage cavity 29 and Sealing the storage cavity 29.

Beneficially, an upward guide hole 27 is provided in the packaging box 32 symmetrically on the left and right sides, and a guide rod 26 is fixedly connected on the lower end of the sealing plate 28 symmetrically on the left and right sides, and the guide rod 26 can slide along the guide hole 27. Furthermore, the upper end of the test tube 30 can slide into the sealing hole 37 to prevent the upper end of the test tube 30 from colliding with the sealing plate 28.

According to the embodiment, the buffer mechanism 102 will be described in detail below. The buffer mechanism 102 includes buffer boxes 39 slidingly connected to the upper and lower ends of the buffer rod 46, respectively. A gas storage cavity 47, the upper and lower ends of the buffer rod 46 respectively extend into the gas storage cavity 47, and the gas storage cavity 47 is provided with ventilation channels 41 symmetrically and connected in the inner walls of the left and right sides. A gas exchange valve 40 is fixed in the air passage 41, and the opening directions of the gas exchange valves 40 on the two sides are opposite, that is, the gas exchange valve 40 on one side opens toward the gas storage cavity 47, and the other side The ventilation valve 40 is opened toward the cavity 12, the buffer box 39 is fixedly connected with a connecting rod 13 at one end far away from the center of symmetry, and eight roller grooves 45 are connected in the inner wall of the cavity 12. The rod 13 extends into the spring groove 15 and can slide along the spring groove 15. A buffer spring 14 is fixedly connected between the connecting rod 13 and the inner wall of the spring groove 15. The buffer rod 46 vibrates up and down, thereby squeezing the gas in the gas storage cavity 47 and passing the two air exchanges 40 can inhale or release air into the air storage cavity 47, that is, when the buffer rod 46 squeezes the gas in the air storage cavity 47 and increases the air pressure, the air is discharged through the air exchange valve 40 on one side. The gas in the gas storage cavity 47 is discharged into the cavity 12, and when the air pressure in the gas storage cavity 47 decreases, the gas is passed from the cavity 12 to the gas storage through the air exchange valve 40 on the other side The air in the cavity 47 keeps the air pressure in the air storage cavity 47 in a dynamic balance, which can reduce the amplitude of the shock of the buffer rod 46 up and down, and can reduce the up and down of the sealing plate 28 and the packaging box 32 The amplitude of the vibration. When the transport vehicle is tilted, the buffer lever 46 drives the buffer box 39 to tilt, and then drives the connecting rod 13 to tilt, and then squeezes or stretches the buffer spring 14 and further the buffer spring. The inclination angle of the connecting rod 13 is reduced under the action of the elastic force of 14 to further reduce the inclination angle of the buffer box 39 and the buffer rod 46, thereby reducing the sealing plate 28 and the packing box 32. The inclination angle can prevent the medicine in the storage cavity 29 from leaking out.

Beneficially, six buffer grooves 45 are provided in the buffer rod 46 with the inner openings facing outward, and a guide pulley 43 is rotatably provided in the roller groove 45, and a fixed shaft 44 is fixedly connected to the guide pulley 43. The fixed shaft 44 is rotatably connected to the buffer rod 46, the guide pulley 43 is provided with an annular groove 49 opening outward, and six guide slide rails 42 are fixed in the inner wall of the air storage cavity 47. A guide slide rail 42 extends into the annular groove 49, and the guide pulley 43 can roll along the guide slide rail 42 to guide sliding between the buffer rod 46 and the air storage cavity 47.

The following is a detailed description of the steps for using an anti-dumping transport case for medical drugs in this article with reference to FIGS. 1 to 6:

Initially, the baffle 50 is in an open state, and the sealing plate 28 is in an unconnected state. At this time, the clamping plate 36 and the bottom plate 33 have not clamped the test tube 30, and the connecting shaft 19 and the screw 17 are not connected at this time.

During use, the test tube 30 is inserted between the clamping plate 36 and the bottom plate 33. The lower end of the test tube 30 is connected to the groove 31 in the bottom plate 33. The test tube 30 is maintained in a vertical state by the clamping plate 36 and the bottom plate 33. The baffle 50 is closed, and air is exhausted from the cavity 12 through the air outlet channel 24, and then the air in the cavity 12 is drawn out of the box body 11. At this time, the manual plate 20 is pushed, thereby driving the connecting shaft 19 to slide down and the screw 17 At this time, the compression spring 21 is compressed. At this time, the manual plate 20 is rotated, and then the connecting shaft 19 is rotated, and the screw 17 is rotated, and the seal plate 28 is lowered, and the guide rod 26 is slid along the guide hole 27, so that the upper end of the test tube 30 It can slide into the sealing hole 37 accurately, the sealing piston 38 slides into the storage cavity 29 and seals the storage cavity 29. At this time, the manual plate 20 is released, and then the manual plate 20 is driven by the elastic force of the compression spring 21 to rise, and The connecting shaft 19 is disconnected from the screw 17, and the inert gas is filled into the cavity 12 through the air outlet channel 24.

When the transportation vehicle vibrates up and down during the transportation, the buffer rod 46 vibrates up and down, and then squeezes the gas in the air storage chamber 47. The air can be taken in or out of the air storage chamber 47 through the two air exchange valves 40. 46 When the gas in the gas storage cavity 47 is squeezed and the pressure is increased, the gas in the gas storage cavity 47 is discharged into the cavity 12 through the vent valve 40 on one side, and when the pressure in the gas storage cavity 47 is reduced, The ventilation valve 40 on the side takes in air from the inside of the cavity 12 to the inside of the air storage cavity 47, so that the air pressure in the air storage cavity 47 can be dynamically balanced, thereby reducing the amplitude of the up and down vibration of the buffer rod 46, and further reducing the sealing plate 28. The amplitude of vibration up and down with the packing box 32. When the transport vehicle is tilted, the buffer lever 46 drives the buffer box 39 to tilt, and then drives the connecting rod 13 to tilt, thereby squeezing or stretching the buffer spring 14, and then under the elastic force of the buffer spring 14. Decreasing the inclination angle of the connecting rod 13 can further reduce the inclination angle of the buffer box 39 and the buffer rod 46, and can further reduce the inclination angle of the sealing plate 28 and the packaging box 32, thereby preventing drug leakage in the storage cavity 29 Go out.

The beneficial effect of the present invention is that the present invention can hold the test tube vertically and seal it with a sealing piston, thereby avoiding leakage of the drug, and keeping the drug in an environment filled with inert gas, and avoiding more impurities such as air. The gas enters the test tube and contaminates the drug, and during transportation, it can reduce the amplitude of the vertical vibration of the test tube and the angle of inclination, thereby preventing the test tube from leaking the drug due to excessive tilt.

In the above manner, those skilled in the art can make various changes according to the working mode within the scope of the present invention.

1. An anti-dumping transport box for medical drugs, including a box body, characterized in that: a cavity is provided in the box body, a clamping mechanism is arranged in the cavity, and a sealing plate and a packing box are passed in the clamping mechanism. Five test tubes can be clamped, the medicine is stored in the storage cavity in the test tube, and the sealing piston in the clamping mechanism can seal the storage cavity;
Friction pads are fixed at four corners between the sealing plate and the packing box, and four buffer rods are arranged in a circular array in the cavity and can slide up and down. The buffer rods and the friction The pads are in contact with each other and are connected to the sealing plate and the packing box. The friction between the buffer rod and the friction pad is equivalent to the weight of the clamping mechanism after the five clamping tubes are clamped by the clamping mechanism.
A buffer mechanism is connected to the upper and lower ends of the buffer rod, and the buffer mechanism can buffer the vertical vibration and tilt of the buffer rod;
A manual mechanism is threadedly connected to the upper end of the sealing plate, and the sealing plate can be driven to be separated from the packing box by manually controlling the manual mechanism;
A baffle is rotatably provided in the cavity, and a baffle shaft is fixedly connected to the baffle. The left and right ends of the baffle shaft are rotatably connected to the left and right inner walls of the cavity.
An air outlet pipe is fixedly connected to the upper end of the box, and an air outlet passage is provided in the air outlet pipe, and the air outlet passage is connected to the cavity. A valve is fixed in the air outlet passage, and the valve can be bidirectional. turn on.

2. The anti-dumping transport case for medical drugs according to claim 1, wherein the manual mechanism comprises a support limit plate fixedly connected to an inner wall on the rear side of the cavity, and the support limit plate rotates inside A screw is connected. The sealing plate is provided with a screw hole with an upward opening in the sealing plate. The lower end of the screw extends into the screw hole and is screwed to the sealing plate. The support limit plate is slidable and rotatable. A connecting shaft is provided in the connecting shaft, and a connecting hole with an opening downward is provided in the connecting shaft. The upper end of the connecting shaft extends outside the box and is manually connected with a manual plate.

3. The anti-dumping transport box for medical drugs according to claim 2, wherein a compression spring is fixedly connected to the upper end of the box body, and the upper end of the compression spring abuts against the manual plate.

4. The anti-dumping transport case for medical drugs according to claim 1, wherein the clamping mechanism comprises a storage cavity provided in the packaging box with an upward opening, and a bottom plate is fixed in the storage cavity. The bottom plate is provided with five grooves with upward openings, and five support columns are fixed on the upper end of the bottom plate. A clamping plate is fixedly connected to the upper end of the support column, and the clamping plate clamps the test tube. The lower end of the test tube extends into the groove, and the test tube is kept vertical by the bottom plate and the clamping plate. Five sealing holes with downward openings are provided in the sealing plate, and the upper end of the test tube extends Into the sealing hole, the sealing piston is fixedly connected to the upper inner wall of the sealing hole.

5. The anti-dumping transport case for medical drugs according to claim 4, characterized in that: the packaging box is provided with an opening upward guide hole symmetrically on the left and right sides, and a guide rod is symmetrically fixed on the lower end of the sealing plate, so that The guide rod can slide along the guide hole.

6. The anti-dumping transport box for medical drugs according to claim 1, wherein the buffer mechanism comprises buffer boxes that are slidably connected to the upper and lower ends of the buffer rod, respectively, and the buffer box is provided with an opening facing the center of symmetry. The upper and lower ends of the buffer rod respectively extend into the gas storage cavity. Symmetrical and connected ventilating channels are provided in the inner walls of the left and right sides of the gas storage cavity. A ventilation valve is provided, and the opening directions of the ventilation valve on both sides are opposite;
A connecting rod is fixedly connected to one end of the buffer box far from the center of symmetry, and eight roller grooves are connected in the inner wall of the cavity. The connecting rod extends into the spring groove and can slide along the spring groove. A buffer spring is fixedly connected between the connecting rod and the inner wall of the spring groove.

7. The anti-dumping transport box for medical drugs according to claim 6, characterized in that: six roller grooves are provided in the buffer rod with the inner openings facing outward, and a guide pulley is rotatably provided in the roller grooves. A fixed shaft is fixedly connected to the guide pulley, and the fixed shaft is rotatably connected to the buffer rod;
The guide pulley is provided with an annular groove with an opening outward, and six guide slide rails are fixed in the inner wall of the gas storage cavity, and the guide slide rails extend into the annular groove.
